(19) United States
(12) Patent Application Publication
(10) Pub. No.: US 2025/0208539 A1
(43) Pub. Date: Jun. 26, 2025

(54) IMAGE FORMING APPARATUS

(71) Applicant: FUJIFILM Business Innovation Corp., Tokyo (JP)

(72) Inventor: Shinji OKUYAMA, Kanagawa (JP)

(73) Assignee: FUJIFILM Business Innovation Corp., Tokyo (JP)

(21) Appl. No.: 18/744,687

(22) Filed: Jun. 16, 2024

(30) Foreign Application Priority Data
Dec. 25, 2023 (JP) 2023-218383

(51) Int. Cl. G03G 15/16; G03G 15/08

(52) U.S. Cl. CPC G03G 15/1605; G03G 15/0877

(57) ABSTRACT

An image forming apparatus includes an image holding body that holds an image developed with a developer on a surface in a state in which the image is arranged in one direction and that is movable in the one direction; and a transfer member that transfers the image of the image holding body to a recording medium, in which, in a case where the surface of the image holding body is divided into plural regions along a direction intersecting the one direction, for each of division regions that are the plural region, a value derived based on information indicating an image density of the image on the surface is acquired, and in a case where the derived value is less than a predetermined value, the developer is supplied to an intermediate region, which is a region between images transferred to the recording medium on the surface and is a region preceding a portion of the image in the corresponding division region.

### CROSS-REFERENCE TO RELATED APPLICATIONS

This application is based on and claims priority under 35 USC 119 from Japanese Patent Application No. 2023-218383 filed Dec. 25, 2023.

### BACKGROUND

### (i) Technical Field

The present invention relates to an image forming apparatus.

### (ii) Related Art

For example, JP2009-271168A discloses a configuration for preventing a vertical streak-like density unevenness and realizing long-term stabilization of a high-quality image by calculating an average image density of an image formed on each division region of division regions which divide an image carrier into a plurality of parts in a width direction and by adjusting an amount of abrasive particles supplied to each division region in accordance with a difference between a reference value and the average image density of each division region during the passage through an interimage region.

### SUMMARY

Here, in an image forming apparatus including an image holding body that holds an image developed with a developer in one direction on a surface and is movable in one direction and a transfer member that transfers the image of the image holding body to a recording medium, in order to maintain a cleaning performance of the image holding body, in a case where the developer that is not transferred to the recording medium is supplied to the surface of the image holding body, a burden of control may be increased in a case where the control of changing a concentration of the developer to be supplied in accordance with a predetermined region is adopted.

Aspects of non-limiting embodiments of the present disclosure relate to an image forming apparatus that suppresses an increase in burden of control as compared with a case of adopting control of changing a concentration of a developer to be supplied in accordance with a predetermined region.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including an image holding body that holds an image developed with a developer on a surface in a state in which the image is arranged in one direction and that is movable in the one direction; and a transfer member that transfers the image of the image holding body to a recording medium, in which, in a case where the surface of the image holding body is divided into a plurality of regions along a direction intersecting the one direction, for each of division regions that are the plurality of regions, a value derived based on information indicating an image density of the image on the surface is acquired, and in a case where the derived value is less than a predetermined value, the developer is supplied to an intermediate region, which is a region between images transferred to the recording medium on the surface and is a region preceding a portion of the image in the corresponding division region.

### BRIEF DESCRIPTION OF THE DRAWINGS

Exemplary embodiment(s) of the present invention will be described in detail based on the following figures, wherein:

FIG. 1 is a diagram showing an image forming apparatus to which the present exemplary embodiment is applied;

FIG. 2 is a perspective view showing a configuration of a transfer cylinder to which the present exemplary embodiment is applied;

FIG. 3 is a perspective view showing a part of a configuration of a fixing unit according to the present exemplary embodiment;

FIG. 4 is a perspective view showing grippers according to the present exemplary embodiment;

FIG. 5 is a diagram showing a surface of an intermediate transfer belt according to a first exemplary embodiment on an upstream side of a secondary transfer position;

FIG. 6 is a block diagram for describing a functional configuration according to the first exemplary embodiment;

FIG. 7 is a flowchart showing a processing procedure in a case where control of toner supply to a corresponding region of a region is performed;

FIGS. 8A to 8C are diagrams showing band examples drawn in corresponding regions of a region, and each of FIGS. 8A, 8B, and 8C shows a result by the flowchart shown in FIG. 7;

FIG. 9 is a diagram showing a surface of an intermediate transfer belt according to a second exemplary embodiment on an upstream side of a secondary transfer position;

FIG. 10 is a flowchart showing a processing procedure in a case where toner supply control to a region is performed;

FIGS. 11A to 11D are diagrams showing band examples of corresponding regions of a region and of a region, and each of FIGS. 11A, 11B, 11C, and 11D shows a result of the flowchart shown in FIGS. 7 and 10;

FIG. 12 is a sectional view of a transfer cylinder showing a relationship between a recessed portion of the transfer cylinder and a gripper accommodated in the recessed portion; and

FIG. 13 is a diagram showing a surface of an intermediate transfer belt according to a third exemplary embodiment on an upstream side of a secondary transfer position.

### DETAILED DESCRIPTION OF THE INVENTION

Hereinafter, exemplary embodiments of the present invention will be described in detail with reference to the accompanying drawings.

### Image Forming Apparatus 1

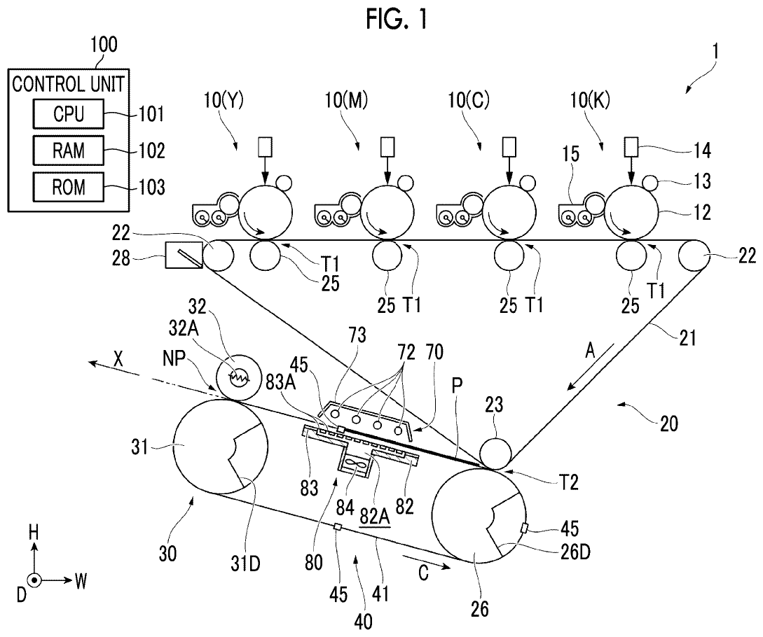

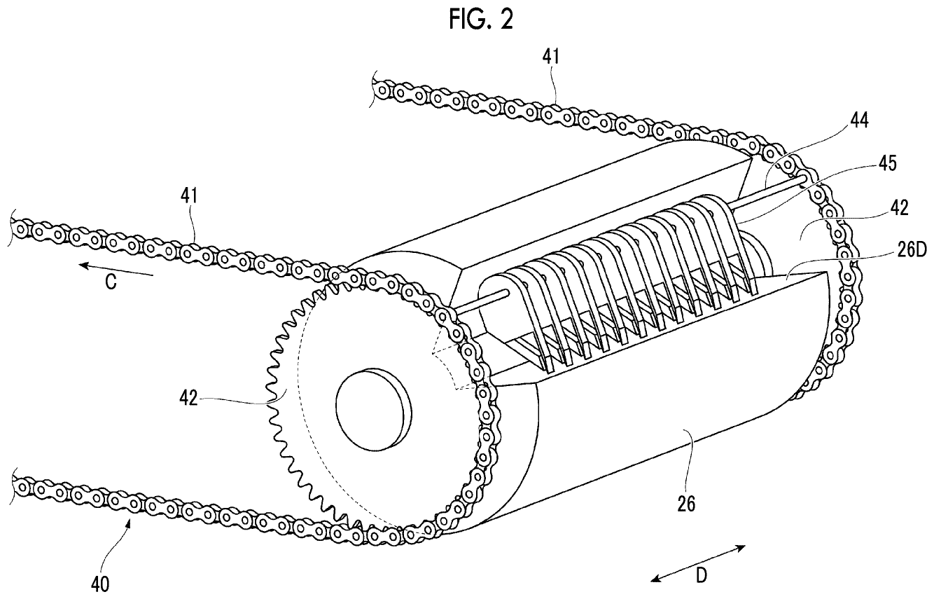

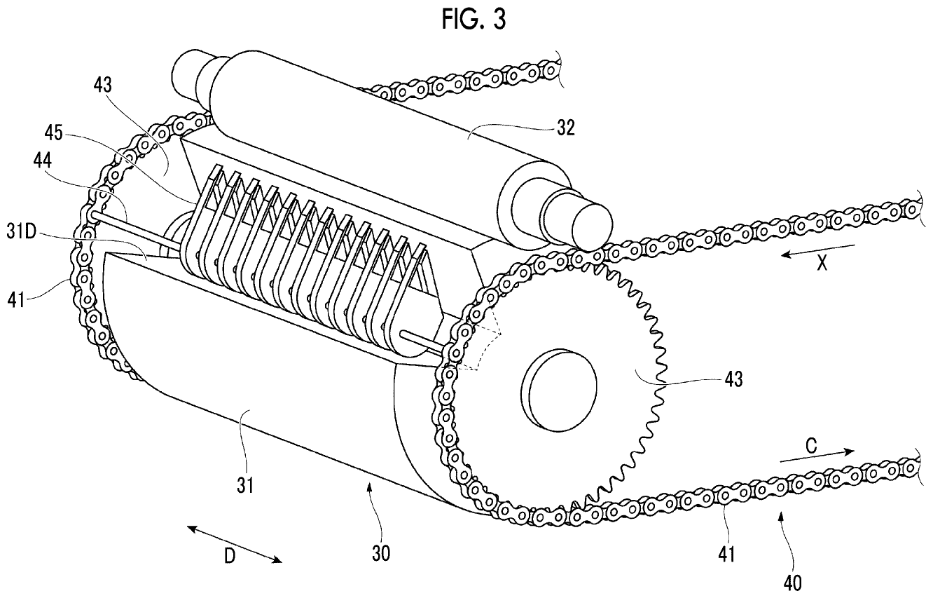

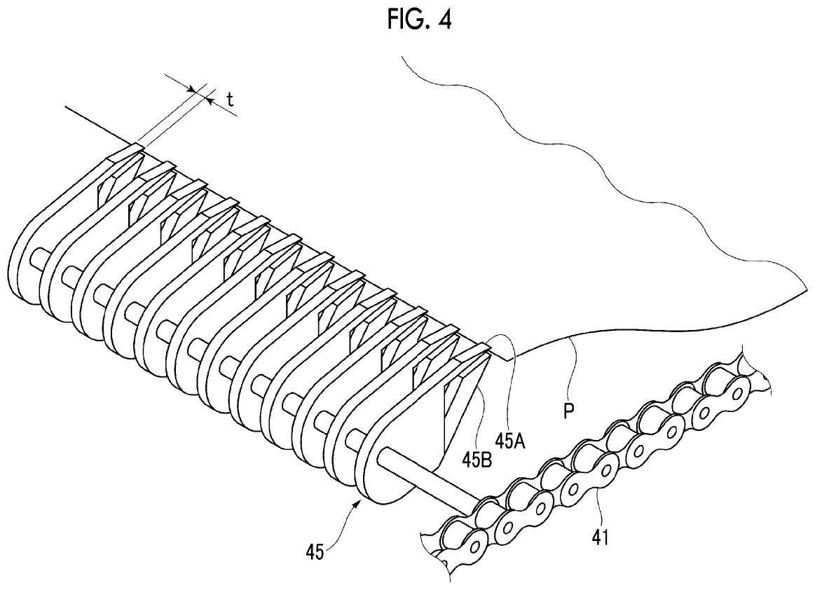

FIG. 1 is a diagram showing an image forming apparatus 1 to which the present exemplary embodiment is applied. FIG. 2 is a perspective view showing a configuration of a transfer cylinder 26 to which the present exemplary embodiment is applied. FIG. 3 is a perspective view showing a part of a configuration of a fixing unit 30 according to the present exemplary embodiment. FIG. 4 is a perspective view showing grippers 45 according to the present exemplary embodiment. For example, an arrow H shown in FIG. 1 indicates a vertical direction and indicates an apparatus up-down direction, an arrow W indicates a horizontal direction and indicates an apparatus width direction, and an arrow D indicates an apparatus front-rear direction (apparatus depth direction). The dimensional ratios of respective portions and the respective portions in a direction of the arrow H (hereinafter, referred to as a direction H), a direction of the arrow W (hereinafter, referred to as a direction W), and a direction of the arrow D (hereinafter, referred to as a direction D) may be different from actual dimensional ratios.

The image forming apparatus 1 shown in FIG. 1 is an example of an image forming apparatus that forms an image on a recording medium P. Examples of the image forming apparatus 1 include an electrophotographic image forming apparatus that forms a toner image on the recording medium P. The toner image is an example of an image developed with a developer.

The image forming apparatus 1 includes an image forming unit 10 that forms a toner image which is an example of an unfixed image, a transfer unit 20 that transfers the toner image formed by the image forming unit 10 to the recording medium P, a fixing unit 30 that fixes the toner image transferred to the recording medium P, a transport unit 40 that transports the recording medium P, and a control unit 100 that controls each unit of the image forming apparatus 1.

### Control Unit 100

The control unit 100 includes a central processing unit (CPU) 101 that controls the entire image forming apparatus 1, a random access memory (RAM) 102 that is used as a work area in calculation, and a read only memory (ROM) 103 that is a memory that stores various programs, various settings, and the like executed by the CPU 101.

### Image Forming Unit 10

The image forming unit 10 has a function of forming a toner image by an electrophotographic method. A plurality of image forming units 10 shown in FIG. 1 are provided to form a toner image for each color. In the present exemplary embodiment, in total, four colors of yellow (Y), magenta (M), cyan (C), and black (K) image forming units 10 are provided. (Y), (M), (C), and (K) shown in FIG. 1 indicate constituent parts corresponding to the respective colors. Note that since the image forming units 10 of respective colors are configured in the same manner except for the toner to be used, each part of the image forming unit 10 (K) is designated by reference numerals to represent the image forming units 10 of respective colors in FIG. 1. The toner is an example of a developer.

The image forming unit 10 of each color includes a photosensitive drum 12 on which an electrostatic latent image is formed while being rotated in a counterclockwise direction in FIG. 1. In addition, the image forming unit 10 of each color includes a charger 13 that charges the surface of the photosensitive drum 12, an exposure device 14 that exposes the photosensitive drum 12, and a developing device 15 that develops an electrostatic latent image formed on the photosensitive drum 12.

### Transfer Unit 20

The transfer unit 20 shown in FIG. 1 is a device that transfers, to the recording medium P, toner images formed by the image forming units 10.

The transfer unit 20 includes an intermediate transfer belt 21 on which a toner image of each color formed on the photosensitive drum 12 of each image forming unit 10 is transferred, and rolls 22 provided on an inner peripheral side of the intermediate transfer belt 21. In addition, the transfer unit 20 includes primary transfer rolls 25 each of which transfers each color toner image of each image forming unit 10 to the intermediate transfer belt 21 at a primary transfer position T1, and an opposing roll 23 and a transfer cylinder 26 that collectively transfer the toner image that has been transferred to the intermediate transfer belt 21, to the recording medium P at a secondary transfer position T2. Further, a blade 28 that removes a toner or the like from the surface of the intermediate transfer belt 21 is provided in the transfer unit 20.

The intermediate transfer belt 21 is an example of an image holding body that is movable in one direction, and the transfer cylinder 26 is an example of a transfer member that transfers an image of the image holding body to the recording medium. The one direction described here is an example of an arrow direction A described later.

The toner image is transferred to an outer peripheral surface of the intermediate transfer belt 21 from the photosensitive drum 12 of each color. As shown in FIG. 1, the intermediate transfer belt 21 has an endless shape and is wound around a plurality of rolls 22 and the opposing roll 23 such that the intermediate transfer belt 21 has an inverted triangular shape as seen in a front view (as seen in the apparatus depth direction). The intermediate transfer belt 21 circulates in the arrow direction A by rotating at least one of the plurality of rolls 22.

In the present exemplary embodiment, by applying a primary transfer electric field between the primary transfer roll 25 and the photosensitive drum 12, the toner image formed on the photosensitive drum 12 is transferred to and held on the surface of the intermediate transfer belt 21 at the primary transfer position T1.

The transfer cylinder 26 is disposed to face the opposing roll 23 with the intermediate transfer belt 21 interposed therebetween. As shown in FIG. 2, the transfer cylinder 26 has a substantially roll shape extending in the D direction. The transfer cylinder 26 includes a recessed portion 26D that accommodates the grippers 45 and that extends in the D direction, in order to transport the grippers 45 described below. The recessed portion 26D is an example of a groove portion that accommodates a grip portion.

In the present exemplary embodiment, the transfer cylinder 26 transfers the toner image that has been transferred to the intermediate transfer belt 21, to the recording medium P at the above-mentioned secondary transfer position T2 between the opposing roll 23 and the transfer cylinder 26. In the present exemplary embodiment, by applying a secondary transfer electric field between the opposing roll 23 and the transfer cylinder 26, the toner image transferred to the intermediate transfer belt 21 is transferred to the recording medium P at the secondary transfer position T2.

As shown in FIG. 1, the blade 28 is disposed on the downstream side of the secondary transfer position T2 in a belt circulation direction and on the upstream side of the image forming unit 10 in the belt circulation direction. The blade 28 is provided over the entire area of the intermediate transfer belt 21 in the width direction (direction perpendicular to the paper surface of FIG. 1). The width direction described here is an example of a direction intersecting the one direction which is a direction in which the image holding body can be moved.

### Fixing Unit 30

The fixing unit 30 shown in FIG. 1 functions as a device that fixes the toner image that has been transferred to the recording medium P by the transfer cylinder 26, to the recording medium P. The fixing unit 30 includes a pressing cylinder 31, and a heating roll 32 that heats the recording medium P by sandwiching the recording medium P together with the pressing cylinder 31. In addition, the fixing unit 30 includes a heating unit 70 that heats the recording medium P before the pressing cylinder 31 and the heating roll 32 sandwich the recording medium P.

### Pressing Cylinder 31 and Heating Roll 32

As shown in FIG. 3, the pressing cylinder 31 has a substantially roll shape extending in the D direction. The pressing cylinder 31 includes a recessed portion 31D that accommodates the grippers 45 and that extends in the D direction, in order to transport the grippers 45.

The heating roll 32 has a heating source 32A (refer to FIG. 1) such as a halogen lamp in the roll, and has a roll shape extending in the D direction.

As shown in FIG. 1, the pressing cylinder 31 and the heating roll 32 are disposed in a vertically aligned manner. Specifically, the heating roll 32 is disposed on an upper side of the pressing cylinder 31 to be inclined with respect to the H direction. Note that, in each drawing, a sandwiching region where the pressing cylinder 31 and the heating roll 32 sandwich the recording medium P is indicated by a reference numeral NP. The sandwiching region NP is a region having a width in a transport direction of the recording medium P.

In the present exemplary embodiment, both the pressing cylinder 31 and the heating roll 32 are rotationally driven. In addition, a configuration may be adopted in which only one of the pressing cylinder 31 and the heating roll 32 is rotationally driven.

### Heating Unit 70

The heating unit 70 shown in FIG. 1 has a function of heating the recording medium P transported in a transport direction X by the transport unit 40 in a non-contact manner. The heating unit 70 is disposed on the upstream side of the heating roll 32 in the transport direction. Accordingly, the heating unit 70 heats the unfixed toner image formed on the surface of the recording medium P in a non-contact manner before the heating roll 32. As shown in FIG. 1, the heating unit 70 includes heaters 72 and a reflective plate 73.

The heater 72 is a heating member that heats the recording medium P in a non-contact manner with respect to the recording medium P transported in the transport direction X by the transport unit 40. As shown in FIG. 1, a plurality of heaters 72 are disposed at intervals along the transport direction X. The heater 72 is configured with a cylindrical infrared heater having a length in the D direction. The filament (not illustrated) provided in the heater 72 generates heat, and the recording medium P is heated by the radiation heat thereof. Note that, in the present exemplary embodiment, as shown in FIG. 1, although four heaters 72 are provided, the number of heaters 72 is not limited to four.

The reflective plate 73 has a function of reflecting the infrared rays from the heaters 72 to the lower side of the device (that is, toward the recording medium P transported by the transport unit 40). Specifically, the reflective plate 73 is formed in a box shape of which the lower side of the device is opened. The reflective plate 73 is formed of, for example, a metal plate such as an aluminum plate.

### Transport Unit 40

The transport unit 40 shown in FIG. 1 has a function of transporting the recording medium P and allowing the recording medium P to pass through the secondary transfer position T2 and the sandwiching region NP. As shown in FIGS. 1 to 3, the transport unit 40 includes a pair of chains 41, a pair of first sprockets 42, and a pair of second sprockets 43. In addition, the transport unit 40 includes an attachment member 44 that is attached across the pair of chains 41, the grippers 45 that are attached to the attachment member 44, and a blowing unit 80. The gripper 45 is an example of a holding portion that holds a leading end portion of the recording medium P. Note that, in FIG. 1, the chains 41 and the gripper 45 are simplified and shown.

As shown in FIG. 2, the pair of first sprockets 42 are disposed on both end sides of the transfer cylinder 26 in an axial direction. The pair of first sprockets 42 are disposed coaxially with the transfer cylinder 26, and are configured to rotate integrally with the transfer cylinder 26. Different chains 41 are wound around the pair of first sprockets 42, respectively.

As shown in FIG. 1, the pair of chains 41 is formed in an annular shape. As shown in FIGS. 2 and 3, the pair of chains 41 are disposed at a distance in the apparatus depth direction (the D direction in the drawings). Each of the pair of chains 41 is wound around the pair of first sprockets 42 (refer to FIG. 2) of the transfer cylinder 26 and the pair of second sprockets 43 (refer to FIG. 3) provided at both ends of the pressing cylinder 31 (refer to FIG. 3) in the axial direction. Then, the pressing cylinder 31 including the pair of second sprockets 43 is rotated so that the chains 41 circulate in a circulation direction C (arrow C direction in FIGS. 1, 2, and 3).

As shown in FIGS. 2 and 3, a plurality of grippers 45 are attached to the pair of chains 41, and the bar-shaped attachment member 44 having a circular cross section is hung along the D direction. A plurality of attachment members 44 are fixed to the pair of chains 41 at a predetermined interval along a circumferential direction (circulation direction C) of the chains 41.

As shown in FIGS. 2 and 3, the plurality of grippers 45 are attached to the attachment member 44 at predetermined intervals along the apparatus depth direction. In other words, the gripper 45 is attached to the chain 41 via the attachment member 44. The gripper 45 has a function of holding the leading end portion of the recording medium P. Specifically, as shown in FIG. 4, the gripper 45 has a claw 45A and a claw base 45B. The gripper 45 is configured to hold the recording medium P with the leading end portion of the recording medium P being sandwiched between the claw 45A and the claw base 45B.

More specifically, the gripper 45 is disposed on the downstream side of the recording medium P in the transport direction, and holds the leading end portion of the recording medium P from the downstream side of the recording medium P in the transport direction as shown in FIG. 4. Note that, regarding the gripper 45, for example, the claw 45A is pressed against the claw base 45B by a spring or the like and the claw 45A is opened or closed with respect to the claw base 45B by the action of a cam or the like. The gripper 45 is an example of a grip portion that grips a portion of the recording medium.

### Blowing Unit 80

The blowing unit 80 shown in FIG. 1 faces the heating unit 70 on a side (that is, a lower side) opposite to the heating unit 70 side (that is, an upper side) of the recording medium P transported by the grippers 45.

The blowing unit 80 has a function of blowing air to a lower surface of the recording medium P transported by the transport unit 40. The blowing unit 80 has a function of maintaining a non-contact state by blowing air to the recording medium P such that the recording medium P is transported by the transport unit 40 in the non-contact state with respect to a rear surface of the recording medium P on a side opposite to the surface on which the toner image is formed.

In the present exemplary embodiment, the blowing unit 80 includes a main body 82, a blowing plate 83, and a blower 84. The main body 82 has a space 82A opened upward in the main body 82.

The blower 84 is provided in a lower portion of the main body 82. The blower 84 sends air to the space 82A of the main body 82. As the blower 84, for example, an axial blower that blows air in the axial direction is used. Note that, as the blower 84, a centrifugal blower that blows air in a centrifugal direction, such as a multi-blade blower (for example, a sirocco fan), may be used.

The blowing plate 83 is provided in an upper portion of the main body 82 to close an opening of the main body 82. The blowing plate 83 faces the heating unit 70 on a side (that is, a lower side) opposite to the heating unit 70 side (that is, an upper side) of the recording medium P transported by the transport unit 40. Further, the blowing plate 83 is formed of a metal or a resin in a plate shape, and has a plurality of blowing holes 83A penetrating in the up-down direction H. The blowing plate 83 allows the air sent from the blower 84 to the space 82A of the main body 82 to pass through the plurality of blowing holes 83A upward to bring the air into contact with the lower surface of the recording medium P, thereby floating the recording medium P and supporting the recording medium P.

Here, in a case where, for example, a region or the like in which the toner is not supplied is present in any region of the intermediate transfer belt 21 in the width direction, the difference in image density in the width direction is noticeable. Accordingly, the posture of the blade 28 over the entire area of the intermediate transfer belt 21 in the width direction is unstable, and the blade 28 may not be able to perform cleaning and thus a stain is generated. In order to prevent the cleaning performance from deteriorating due to the unstable posture of the blade 28, the amount of the toner transported to the blade 28 without being secondarily transferred may be secured.

In a case where the toner supply to the surface of the intermediate transfer belt 21 held up to the blade 28 is performed in a plurality of regions divided in the width direction, for example, it is preferable that the control of the toner supply is easily performed.

Therefore, in the present exemplary embodiment, control of calculating an average image density for each of the plurality of divided regions and supplying the toner to a region in which the average image density is lower than a predetermined threshold value among the plurality of regions is adopted.

Hereinafter, the first exemplary embodiment, the second exemplary embodiment, and the third exemplary embodiment will be specifically described.

### First Exemplary Embodiment

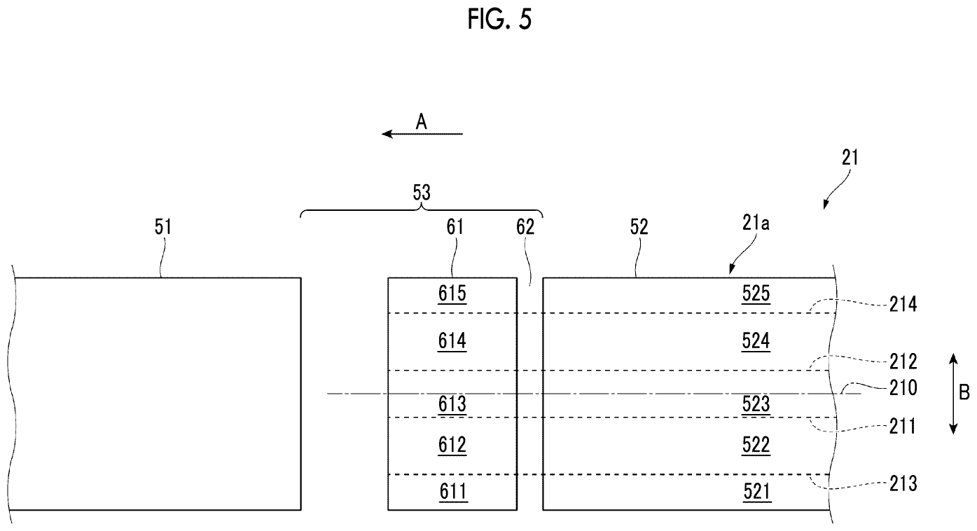

FIG. 5 is a diagram showing a surface 21a of the intermediate transfer belt 21 according to the first exemplary embodiment on the upstream side of the secondary transfer position T2, and shows a state before the secondary transfer.

### Toner Image Regions 51 and 52

In the example shown in FIG. 5, toner image regions 51 and 52, which are ranges where the toner images to be secondarily transferred can be held, are set in the intermediate transfer belt 21. The toner image to be secondarily transferred is held at a predetermined position in the toner image regions 51 and 52. The toner image regions 51 and 52 are ranges where the images developed with the developer are held.

The toner images of the toner image regions 51 and 52 are examples of images on the surface of the image holding body, and examples of images transferred to the recording medium.

The toner image regions 51 and 52 correspond to the size of the recording medium P, for example, the size such as the standard size and the nobi size of B2, but can also correspond to a size smaller than the size of the recording medium P.

In FIG. 5, the upstream side of the toner image region 51 and the downstream side of the toner image region 52 are broken and shown.

In addition, the positions of the toner image regions 51 and 52 with respect to the recording medium P are predetermined with respect to a width direction B that is an example of a direction intersecting the arrow direction A.

That is, in a case where the center position of the recording medium P in the width direction B is installed at the center position of the toner image regions 51 and 52 (so-called center registration), the center of the toner image transferred to the recording medium P is held at the center position in the width direction B. On the other hand, in a case where the position of one end portion of the recording medium P in the width direction B is installed to be close to one end portions of the toner image regions 51 and 52 on the same side (so-called side registration), the toner image transferred to the recording medium P is held at the position close to the one end portion.

Note that the toner image regions 51 and 52 may be provided across both ends of the intermediate transfer belt 21 and have the full width in the width direction B, or may be provided such that predetermined width portions at both ends are excluded.

Furthermore, the toner image regions 51 and 52 are held side by side on the surface 21a of the intermediate transfer belt 21 in the arrow direction A. More specifically, the toner image region 51 is positioned on the upstream side of the toner image region 52 in the arrow direction A, and is subjected to secondary transfer before the toner image region 52.

### Division Regions 521 to 525 of Toner Image Region 52

Here, with reference to FIG. 5, broken lines 211, 212, 213, and 214 extend in the arrow direction A on the surface 21a of the intermediate transfer belt 21.

The broken lines 211 to 214 are positioned with respect to the position of a center line 210. More specifically, the center line 210 is a position at the center in the width direction B. Moreover, the broken lines 211 and 212 have the same distance from the center line 210, and the broken lines 213 and 214 have the same distance from the center line 210. That is, the broken lines 211 to 214 are at positions that are symmetrical with respect to the center line 210. The distance between the broken line 211 and the broken line 213 is equal to the distance between the broken line 212 and the broken line 214.

In addition, the distance between the broken line 211 and the broken line 212 is different from the distance between the broken line 211 and the broken line 213 and the distance between the broken line 212 and the broken line 214.

Here, the image forming apparatus 1 is the center registration device described above. Therefore, as shown in FIG. 5, division regions 521 to 525 are set on the basis of the position of the center line 210, which is the center of the recording medium P in the width direction, in the width direction B.

Note that, in the example shown in FIG. 5, the number of broken lines 211 to 214 is four, but the present invention is not limited to this, and other numbers can be considered. In addition, the positions of the broken lines 211 to 214 with respect to the center line 210 are not limited to the example shown in FIG. 5, and the intervals between the broken lines 211 to 214 adjacent to each other are not limited thereto.

Note that, for example, among the four broken lines 211 to 214, the positions of the broken lines 213 and 214 may correspond to the positions of the ends of the recording medium P. In such a case, control of changing the positions of the broken lines 213 and 214 in accordance with the positions of the ends of the size of the recording medium P may be adopted. Note that the remaining broken lines 211 and 212 may divide the recording medium P evenly in the width direction B, or the interval between the broken lines 211 and 212 may be narrowed so that the central portion of the recording medium P is divided narrowly.

The toner image region 52 of the surface 21a is divided into a plurality of regions along the width direction B by the four broken lines 211 to 214. That is, the toner image region 52 is divided into five regions by the broken lines 211 to 214, so that the division regions 521, 522, 523, 524, and 525 are formed. Each of the division regions 521 to 525 has a portion of the image secondarily transferred to the toner image region 52. The division regions 521 to 525 are examples of division regions.

Note that, in the example shown in FIG. 5, since the number of broken lines 211 to 214 is four, the toner image region 52 is divided into five regions in the width direction B. However, the present invention is not limited thereto, and the number of regions may be more than five, for example, eight or nine, or the number of regions is less than five, for example, three or four.

### Margin Region 53

Further, on the surface 21a of the intermediate transfer belt 21, a margin region 53 is positioned between the toner image region 51 and the toner image region 52 in the arrow direction A. The margin region 53 is provided over the entire width in the width direction B.

The margin region 53 includes a region 61 to which the toner is supplied and a region 62 to which the toner is not supplied. The margin region 53 is a region preceding the image in the toner image region 52 and is an example of an intermediate region.

The region 61 is positioned on the downstream side of the region 62 in the arrow direction A.

The region 62 is positioned between the region 61 and the toner image region 52. The region 62 is a region used for performing inclination correction in a case where, for example, the intermediate transfer belt 21 is inclined or the recording medium P to be transported is inclined.

Note that, in the example shown in FIG. 5, the toner image region 51, the region 61 and region 62 of the margin region 53, and the toner image region 52 arrive at the secondary transfer position T2 in this order. The margin region 53 precedes the toner image region 52.

The transfer bias is switched from ON to OFF before the margin region 53 reaches the secondary transfer position T2 such that the toner supplied to the margin region 53 is not secondarily transferred.

### Corresponding Regions 611 to 615 of Region 61

Here, the region 61 includes corresponding regions 611, 612, 613, 614, and 615 at positions corresponding to the division regions 521 to 525 of the toner image region 52. In other words, the region 61 includes the corresponding regions 611 to 615 positioned to be divided by the broken lines 211 to 214.

Further, the region 61 includes the corresponding regions 611 to 615 in the region preceding the division regions 521 to 525 of the toner image region 52 in the arrow direction A. More specifically, the region 61 includes the corresponding region 611 as the region preceding the division region 521, the corresponding region 612 as the region preceding the division region 522, the corresponding region 613 as the region preceding the division region 523, the corresponding region 614 as the region preceding the division region 524, and the corresponding region 615 as the region preceding the division region 525.

As described above, in each of the corresponding regions 611 to 615, the toner can be supplied over the entire area of the corresponding regions 611 to 615, but a region to which the toner is not supplied may be included. That is, each of the corresponding regions 611 to 615 includes a part of the region 61, but may include a part of the region 62. In such a case, in the corresponding regions 611 to 615, the toner can be supplied to the portion corresponding to the region 61, but the toner is not supplied to the portion corresponding to the region 62.

The region 62 is an example of the region to which the developer is not supplied.

Next, control of the toner supply to the corresponding regions 611 to 615 of the region 61 will be described.

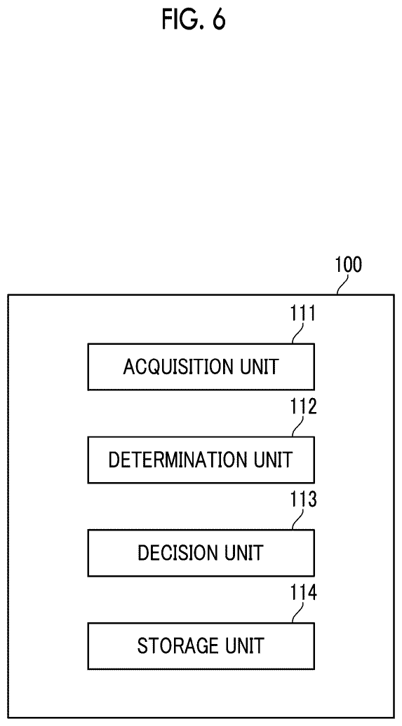

FIG. 6 is a block diagram for describing a functional configuration according to the first exemplary embodiment.

In the configuration example shown in FIG. 6, the control unit 100 includes an acquisition unit 111, a determination unit 112, a decision unit 113, and a storage unit 114.

The acquisition unit 111 acquires, by calculation, the average image density of the division regions 521 to 525 (refer to FIG. 5) in a case where the image formed by the image forming unit 10 (refer to FIG. 1) is transferred to the toner image region 52 (refer to FIG. 5) of the intermediate transfer belt 21 at the primary transfer position T1 (refer to FIG. 1). The average image density described here includes a value of the entire division regions 521 to 525 and a value of each of the division regions 521 to 525.

The average image density described here is, for example, calculated by using the image forming unit 10 of each color as a unit, normalizing the acquired exposure amount, calculating the exposure amount of the division regions, calculating the driving time, and integrating the exposure amount and the driving time.

The average image density is an example of a value derived on the basis of information indicating the image density.

The determination unit 112 performs predetermined determination using the average image density of the division regions 521 to 525 (refer to FIG. 5) acquired by the acquisition unit 111 and the information such as a threshold value stored in the storage unit 114 to be described later. The details will be described below.

The decision unit 113 decides whether or not to draw a toner band (hereinafter, abbreviated as a “band”) in the margin region 53 according to the determination result by the determination unit 112.

In the first exemplary embodiment, it is decided whether or not to draw the band in each of the corresponding regions 611 to 615 (refer to FIG. 5) of the region 61, and it is decided what color or concentration of the toner is used in a case of drawing the band. The information regarding the color or concentration of the toner is stored in the storage unit 114 to be described later.

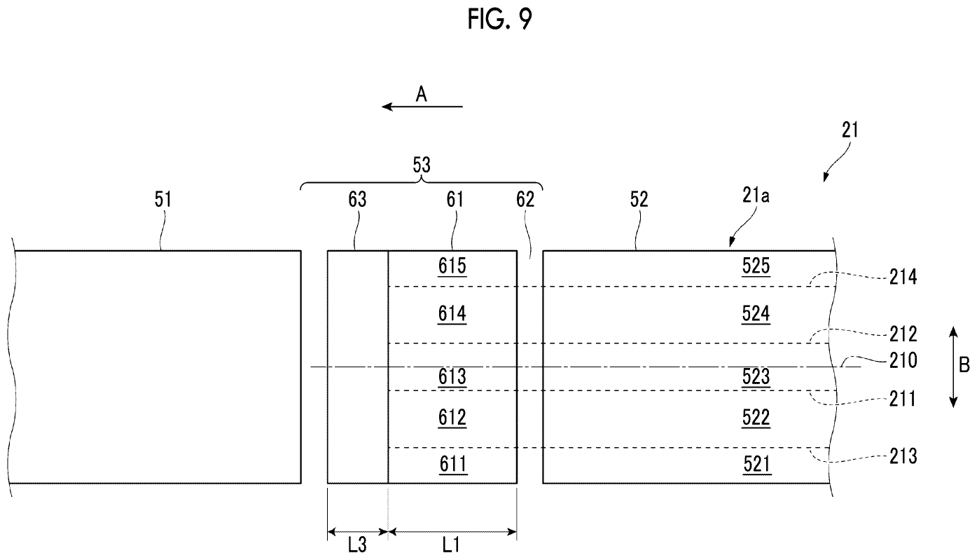

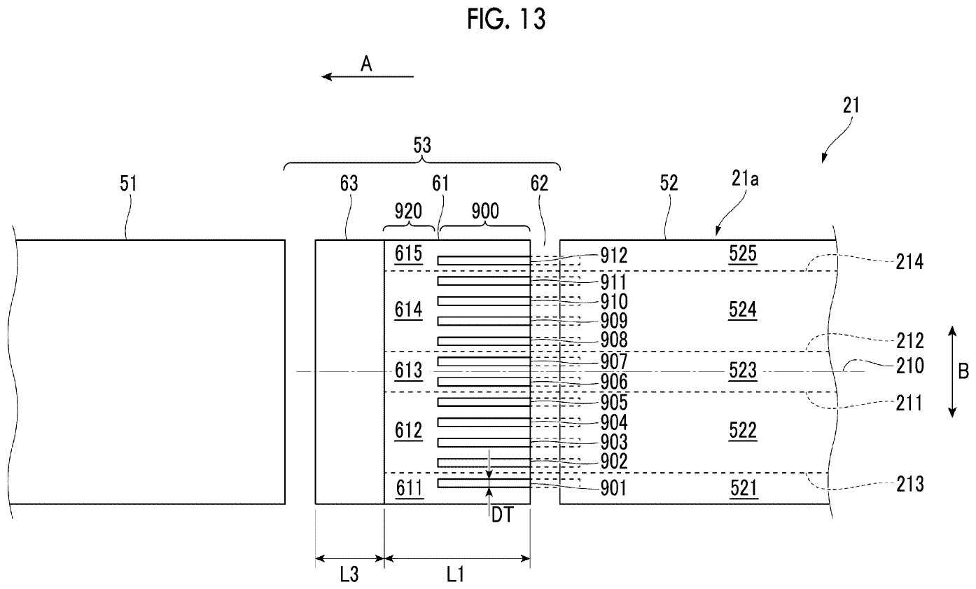

In addition, in a second exemplary embodiment and a third exemplary embodiment to be described later, it is decided whether or not to further draw the band in a region 63 (refer to FIG. 9 or FIG. 13) and it is decided what color or concentration of the toner is used in a case of drawing the band.

The storage unit 114 stores information such as the threshold value used for the determination by the determination unit 112 and information necessary for the decision by the decision unit 113. Such information is variable.

The storage unit 114 is a non-volatile memory (NVM) in which data is not lost even in a case where power is turned off, and is configured with the RAM 102 (refer to FIG. 1).

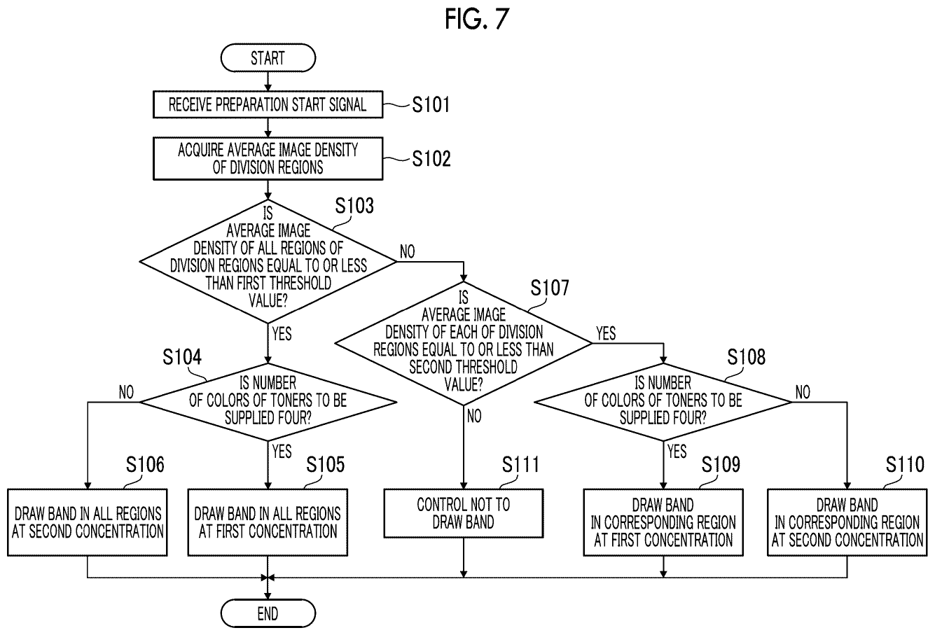

FIG. 7 is a flowchart showing a processing procedure in a case where control of the toner supply to the corresponding regions 611 to 615 of the region 61 is performed.

In a processing example shown in FIG. 7, in a case where a preparation start signal for a printing instruction is received (step S101), the acquisition unit 111 (refer to FIG. 6) acquires the average image density of the division regions 521 to 525 (step S102).

Then, the determination unit 112 (refer to FIG. 6) determines whether or not the average image density in all the regions of the division regions 521 to 525, that is, of the toner image region 52 is equal to or less than a first threshold value (step S103). The first threshold value is a value stored by the storage unit 114, and is variable.

In a case where the average image density of all the regions of the division regions 521 to 525 is equal to or less than the first threshold value (Yes in step S103), it is further determined whether or not the number of colors of the toners to be supplied is four in a case where the toners are supplied to all the regions of the corresponding regions 611 to 615 (step S104). The four colors referred to here are the maximum number of colors in the present exemplary embodiment, and are YMCK included in the image forming apparatus 1. Therefore, in a case where the image forming apparatus 1 includes a toner of a color other than YMCK, the above-described determination may be performed in accordance with the number of toners.

In a case where the number of colors is four (Yes in step S104), the decision unit 113 (refer to FIG. 6) controls such that the band is drawn in all the regions of the corresponding regions 611 to 615 at a first concentration (step S105). On the other hand, in a case where the number of colors is three or less (No in step S104), control is performed such that the band is drawn in all the regions of the corresponding regions 611 to 615 at a second concentration higher than the first concentration (step S106).

In a case where the average image density in all the regions of the division regions 521 to 525, that is, in the toner image region 52 exceeds the first threshold value, as a case where the average image density is not equal to or less than the first threshold value (No in step S103), it is determined whether or not the band drawing is required for each of the corresponding regions 611 to 615. That is, it is determined whether or not the average image density of each of the division regions 521 to 525 is equal to or less than a second threshold value (step S107). In other words, it is determined whether or not the determination result of at least any one of the division regions 521 to 525 is the average image density equal to or less than the second threshold value.

The second threshold value is a value stored by the storage unit 114, and is variable.

In a case where the determination result of at least any one of the division regions 521 to 525 is the average image density equal to or less than the second threshold value (Yes in step S107), it is determined whether or not the number of colors in a case of supplying the toner to the intermediate region corresponding to the corresponding division region is four (step S108).

For example, in a case where, among the division regions 521 to 525, only the division region 521 and the division region 525 have the average image density equal to or less than the second threshold value, the number of colors is determined only for the corresponding region 611 corresponding to the division region 521 and the corresponding region 615 corresponding to the division region 525.

The determination of the number of colors may be performed on the basis of the consumption amount of each toner of YMCK. For example, in a case where the consumption amount of any of YMCK is larger than the consumption amounts of the other colors, other toners may be used, and in a case where the difference in consumption amount is small, the determination that four colors are used may be performed.

In a case where the number of colors is four (Yes in step S108), the decision unit 113 (refer to FIG. 6) controls such that the band is drawn in the corresponding region among the corresponding regions 611 to 615 at the first concentration (step S109). On the other hand, in a case where the number of colors is three or less (No in step S108), control is performed such that the band is drawn in the corresponding region among the corresponding regions 611 to 615 at the second concentration higher than the first concentration (step S110).

In a case where any determination result of the division regions 521 to 525 is not the average image density equal to or less than the second threshold value (No in step S107), control is performed such that no band is drawn in any of the corresponding regions 611 to 615 (step S111).

Note that the second threshold value used in the determination for the division regions 521 to 525 is not changed for each of the division regions 521 to 525, and is the identical value.

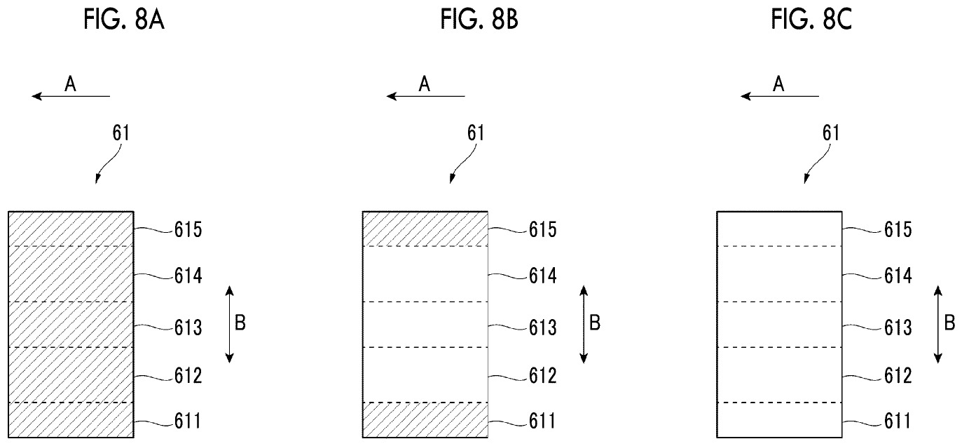

FIGS. 8A to 8C are diagrams showing band examples drawn in the corresponding regions 611 to 615 of the region 61, and each of FIGS. 8A, 8B, and 8C shows the result by the flowchart shown in FIG. 7.

In the example shown in FIG. 8A, a band (refer to oblique lines) is drawn in the entire region of the region 61.

More specifically, the band example shown in FIG. 8A is obtained by step S105 or step S106 of FIG. 7. That is, in a case where the average image density in all the regions of the division regions 521 to 525 (refer to FIG. 5) is equal to or less than the first threshold value, the band (refer to oblique lines) having the same concentration is drawn in each of the corresponding regions 611 to 615. Note that, in FIGS. 8A to 8C, the difference in concentration of the band is not distinguished.

In the example shown in FIG. 8B, the band (refer to oblique lines) is drawn in the corresponding regions 611 and 615, but the band is not drawn in the other corresponding regions 612 to 614.

More specifically, the band example shown in FIG. 8B is obtained by step S109 or step S110 of FIG. 7. That is, in a case in which the division regions satisfying the condition that the average image density is equal to or less than the second threshold value are the division regions 521 and 525 among the division regions 521 to 525 (refer to FIG. 5), the band (refer to oblique lines) having the same concentration is drawn only in the corresponding regions 611 and 615 corresponding to the division regions 521 and 525, and no band is drawn in the remaining corresponding regions 612 to 614.

In the example shown in FIG. 8C, no band is drawn in any of the corresponding regions 611 to 615.

More specifically, the band example shown in FIG. 8C is obtained by step S111 of FIG. 7, and no band is drawn in any of the corresponding regions 611 to 615.

As described above, in the first exemplary embodiment, since the determination method for the division regions 521 to 525 is not different for each of the division regions 521 to 525 and the concentration of the band to be drawn is not different for each of the division regions 521 to 525, an increase in burden of the control is suppressed as compared with a case where the determination method and the concentration of the band are changed for each of the division regions 521 to 525.

### Second Exemplary Embodiment

FIG. 9 is a diagram showing the surface 21a of the intermediate transfer belt 21 according to the second exemplary embodiment on the upstream side of the secondary transfer position T2, and shows a state before the secondary transfer. FIG. 9 corresponds to FIG. 5 in the first exemplary embodiment, and the same configuration as that shown in FIG. 5 will be designated by the same reference numerals and the description thereof will be omitted.

### Region 63

As shown in FIG. 9, in the second exemplary embodiment, in the intermediate transfer belt 21, the margin region 53 positioned between the toner image region 51 and the toner image region 52 in the arrow direction A also includes the region 63 to which the toner is supplied in addition to the region 61 to which the toner is supplied and the region 62 to which the toner is not supplied.

As described above, the region 63 constitutes a part of the margin region 53, and is positioned on the upstream side of the region 61, that is, the corresponding regions 611 to 615 in the arrow direction A.

The region 63 is provided over the entire area in the width direction B, and is different from the region 61 in that the region 63 is not divided by the broken lines 211 to 214.

The region 63 is an example of a region extending over the entire area in a direction intersecting the one direction.

As described above, in the second exemplary embodiment, not only the region 61 but also the region 63 is set as the band drawing region, and thus, even in a case where the image density in the toner image region 52 is extremely low, a large amount of toner is supplied, and the posture of the blade 28 (refer to FIG. 1) is stabilized.

As shown in FIG. 9, the dimension of the region 61 in the arrow direction A is a length L1, and the dimension of the region 63 in the arrow direction A is a length L3. More specifically, the length L1 of the region 61 and the length L3 of the region 63 are different from each other, and the length L1 is longer than the length L3 (L1>L3).

That is, the length L1 of the region 61 in the arrow direction A is longer than the length of the region 63.

As described in the first exemplary embodiment, since it is decided whether or not to draw the band in accordance with the average image density of each of the division regions 521 to 525 (refer to FIG. 5) of the toner image region 52, in a case where the image density of a part of the division regions 521 to 525 is extremely low, a larger amount of toner is supplied to the region 61 by lengthening the region 61, and the posture of the blade 28 (refer to FIG. 1) is stabilized.

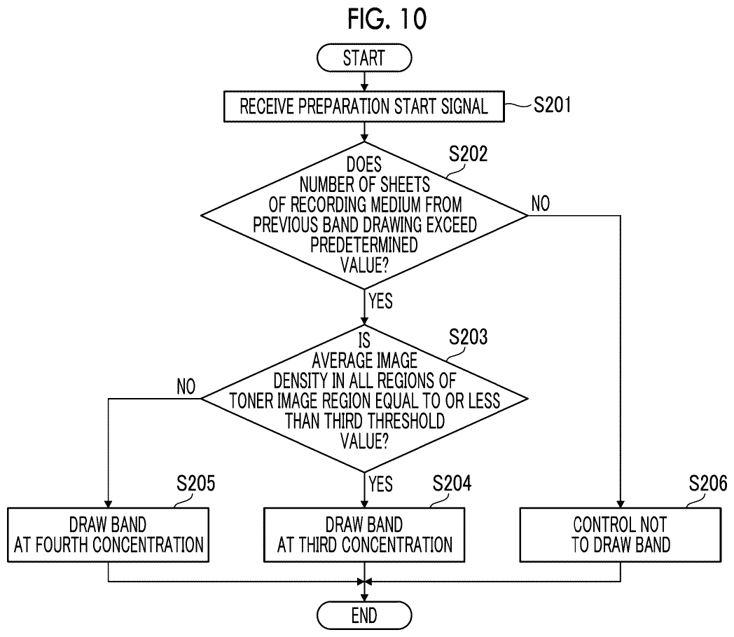

FIG. 10 is a flowchart showing a processing procedure in a case where toner supply control to the region 63 is performed. Note that in the second exemplary embodiment, as the processing procedure in a case where the control of the toner supply to the corresponding regions 611 to 615 of the region 61 is performed, the processing procedure described in the first exemplary embodiment and shown in FIG. 7 can be adopted.

In the processing example shown in FIG. 10, in a case where the preparation start signal for the printing instruction is received (step S201), the acquisition unit 111 (refer to FIG. 6) determines whether or not the number of sheets of the recording medium P from the previous band drawing exceeds a predetermined value (step S202). The predetermined value is a value stored by the storage unit 114, and is variable. In a case where the predetermined value is, for example, “1”, the positive determination is made for every other sheet of the recording medium P.

Although not shown in FIG. 10, for the first recording medium P in a case where the image forming apparatus 1 performs printing after the power is turned on, the determination in step S202 is affirmative, and the processing proceeds to step S203 described below.

In a case where the number of sheets of the recording medium P from the previous band drawing exceeds the predetermined value (Yes in step S202), the determination unit 112 (refer to FIG. 6) determines whether or not the average image density in all the regions of the toner image region 52 is equal to or less than a third threshold value (step S203). Note that step S203 is different from the case of the first exemplary embodiment described above (refer to FIG. 7) in that the determination for the average image density of each of the division regions 521 to 525 is not performed.

The third threshold value is a value stored by the storage unit 114 (refer to FIG. 6), and is variable. The third threshold value may be set to the same value as the first threshold value in the first exemplary embodiment described above.

In a case where the average image density is equal to or less than the third threshold value (Yes in step S203), the control is performed such that the band is drawn in the region 63 at a third concentration (step S204). On the other hand, in a case where the average image density exceeds the third threshold value (No in step S203), the control is performed such that the band is drawn in the region 63 at a fourth concentration lower than the third concentration (step S205).

The third concentration and the fourth concentration are values stored by the storage unit 114 (refer to FIG. 6), and are variable.

In a case where the number of sheets of the recording medium P from the previous band drawing does not exceed the predetermined value (No in step S202), the control is performed such that the band is not drawn in the region 63 (step S206).

As described above, the band drawing to the region 63 is controlled by a processing procedure different from the case of the band drawing to the corresponding regions 611 to 615 of the region 61 (refer to FIG. 7).

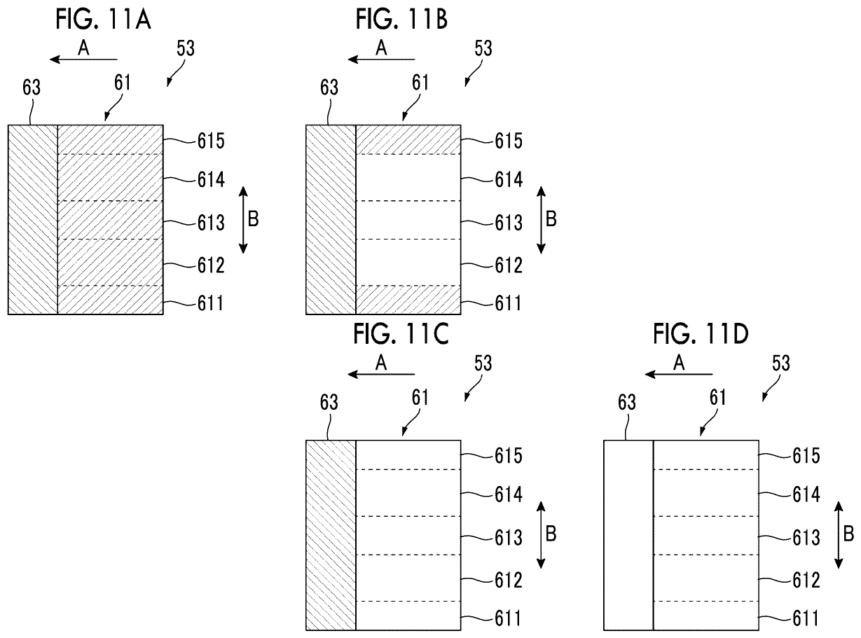

FIGS. 11A to 11D are diagrams showing band examples of the corresponding regions 611 to 615 of the region 61 and of the region 63, and each of FIGS. 11A, 11B, 11C, and 11D shows the result of the flowchart shown in FIGS. 7 and 10. That is, the flowchart shown in FIG. 7 is used for the region 61, and the flowchart shown in FIG. 10 is used for the region 63.

FIGS. 11A to 11D correspond to FIGS. 8A to 8C describing the first exemplary embodiment. Note that, in FIGS. 11A to 11D, the difference in concentration of the band is not distinguished.

In the example shown in FIG. 11A, a band (refer to oblique lines) is drawn in the regions 61 and 63.

More specifically, in the band example shown in FIG. 11A, the region 61 is obtained by step S105 or step S106 of FIG. 7, and the region 63 is obtained by step S204 or step S205 of FIG. 10. That is, in a case where the average image density in all the regions of the division regions 521 to 525 (refer to FIG. 5) is equal to or less than the first threshold value, the band (refer to oblique lines) having the same concentration is drawn in each of the corresponding regions 611 to 615. In addition, in a case where the average image density in all the regions of the division regions 521 to 525 (refer to FIG. 5) is equal to or less than the third threshold value, the band (refer to oblique lines) is drawn in the region 63.

In the example shown in FIG. 11B, the band (refer to oblique lines) is drawn only in the corresponding regions 611 and 615 among the corresponding regions 611 to 615, and the band (refer to oblique lines) is drawn in the region 63.

More specifically, in the band example shown in FIG. 11B, the corresponding regions 611 to 615 are obtained by step S109 or step S110 of FIG. 7, and the region 63 is obtained by step S204 or step S205 of FIG. 10.

In the example shown in FIG. 11C, no band is drawn in any of the corresponding regions 611 to 615, but the band (refer to oblique lines) is drawn in the region 63.

More specifically, in the band example shown in FIG. 11C, the corresponding regions 611 to 615 are obtained by step S111 of FIG. 7, and the region 63 is obtained by step S204 or step S205 of FIG. 10.

In the example shown in FIG. 11D, no band is drawn in any of the corresponding regions 611 to 615 and the region 63.

More specifically, in the band example shown in FIG. 11D, the corresponding regions 611 to 615 are obtained by step S111 of FIG. 7, and the region 63 is obtained by step S206 of FIG. 10.

Here, in addition to a case where the band drawn in the region 61 and the band drawn in the region 63 have the same concentration, a case where the band drawn in the region 61 and the band drawn in the region 63 have different concentrations from each other is also considered.

In addition, in addition to a case where the band drawn in the region 61 and the band drawn in the region 63 are the same toner or a combination of the same toners, a case where the band drawn in the region 61 and the band drawn in the region 63 are different toners or a combination of different toners is also considered.

Further, the control is performed such that the type of the toner is not changed in the region, which is a drawing target for which the decision is made to draw the band. For example, in a case where the drawing target is the region 61, the type of the toner in the region 61 is not changed, in a case where the drawing target is any of the corresponding regions 611 to 615, the type of the toner in the corresponding intermediate region is not changed, and in a case where the drawing target is the region 63, the type of the toner in the region 63 is not changed. However, the present invention is not limited thereto, and control may be performed to obtain different types of toners or a combination thereof in the arrow direction A and the width direction B.

### Third Exemplary Embodiment

Here, as described above, the toner supplied to the margin region 53 (for example, refer to FIG. 5) of the intermediate transfer belt 21 reaches the blade 28 (refer to FIG. 1) without being secondarily transferred at the secondary transfer position T2, and the posture of the blade 28 is stabilized in a case where the blade 28 cleans the surface of the intermediate transfer belt 21.

On the other hand, the grippers 45 are accommodated in the recessed portion 26D of the transfer cylinder 26 (for example, refer to FIG. 2).

Therefore, in a case where the toner of the margin region 53 adheres to the grippers 45 of the transfer cylinder 26, the function of the grippers 45 may be inhibited.

Therefore, in the third exemplary embodiment, the configuration for suppressing the adhesion of the toner of the margin region 53 to the grippers 45 of the transfer cylinder 26 is provided.

This will be described below.

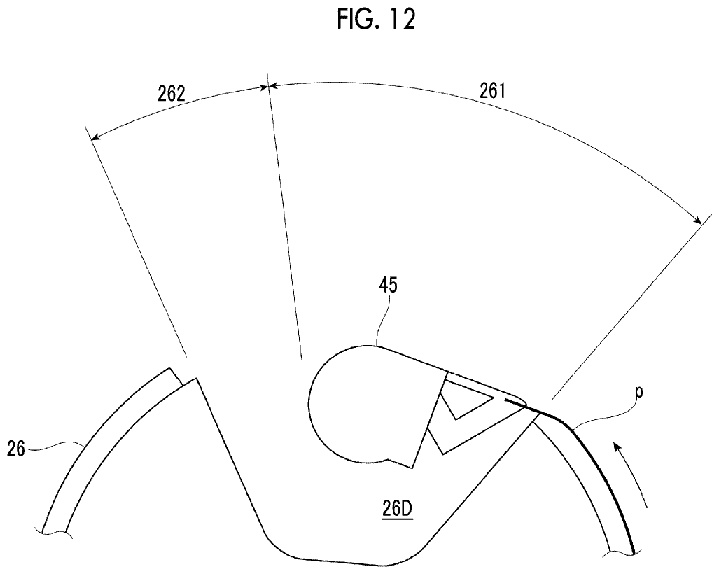

FIG. 12 is a sectional view of the transfer cylinder 26 showing a relationship between the recessed portion 26D of the transfer cylinder 26 and the gripper 45 accommodated in the recessed portion 26D.

As shown in FIG. 12, the recessed portion 26D of the transfer cylinder 26 has a first section 261 that is a section where the grippers 45 are positioned and a second section 262 that is a section where the grippers 45 are not positioned, on the peripheral surface of the transfer cylinder 26.

As described above, the gripper 45 is an example of the grip portion, and the recessed portion 26D is an example of the groove portion that accommodates the grip portion. The second section 262 is an example of a portion where the grip portion is not positioned in the one direction.

Here, in the intermediate transfer belt 21, in a case where the grippers 45 grip the recording medium P on which the toner image of the toner image region 52 (for example, refer to FIG. 5) is secondarily transferred, the toner of the margin region 53 may adhere to any of the first section 261 and the second section 262 shown in FIG. 12.

In a case where the toner adheres to the first section 261 where the grippers 45 are positioned, the function of the grippers 45 may be inhibited. On the other hand, in a case where the toner adheres to the second section 262 where the grippers 45 are not positioned, the function of the grippers 45 may be inhibited.

In addition, in a case where the toner can be supplied to as wide a region as possible in the margin region 53, the posture of the blade 28 (refer to FIG. 1) can be further stabilized.

Therefore, in the third exemplary embodiment, in the margin region 53 of the intermediate transfer belt 21, different control is performed for the toner supply between the region corresponding to the first section 261 where the grippers 45 are positioned and the region corresponding to the second section 262 where the grippers 45 are not positioned. That is, the toner is not supplied to the region corresponding to the first section 261 which is the former, while the toner is supplied to the second section 262 where the grippers 45 are not positioned which is the latter.

This will be described below.

FIG. 13 is a diagram showing the surface 21a of the intermediate transfer belt 21 according to the third exemplary embodiment on the upstream side of the secondary transfer position T2, and shows a state before the secondary transfer. FIG. 13 corresponds to FIG. 5 in the first exemplary embodiment and FIG. 9 in the second exemplary embodiment, and the same configurations as the configurations in FIGS. 5 and 9 will be designated by the same reference numerals and the description thereof will be omitted.

### Corresponding Upstream Region 900 and Corresponding Downstream Region 920

As shown in FIG. 13, in the third exemplary embodiment, the region 61 in the margin region 53 of the intermediate transfer belt 21 is divided into a corresponding upstream region 900 corresponding to the first section 261 (refer to FIG. 12) and a corresponding downstream region 920 corresponding to the second section 262 (refer to FIG. 12) in the recessed portion 26D of the transfer cylinder 26 with respect to the arrow direction A. The corresponding upstream region 900 and the corresponding downstream region 920 are positioned to deviate in the arrow direction A. More specifically, the corresponding downstream region 920 is positioned on the upstream side of the corresponding upstream region 900. In other words, the corresponding downstream region 920 is adjacent to the region 63.

In the example shown in FIG. 13, the length of the corresponding upstream region 900 in the arrow direction A is longer than the length of the corresponding downstream region 920 in the arrow direction A, but the present invention is not limited thereto, and a case where of the corresponding upstream region 900 in the arrow direction A is shorter than the length of the corresponding downstream region 920 in the arrow direction A is also considered.

### Specific Regions 901 to 912 of Corresponding Upstream Region 900

As shown in FIG. 13, in the corresponding upstream region 900 of the region 61, specific regions 901, 902, 903, 904, 905, 906, 907, 908, 909, 910, 911, and 912 provided corresponding to the positions of the grippers 45 are provided in the width direction B. The shapes of the specific regions 901 to 912 are identical. Note that the specific regions 901 to 912 are regions corresponding to the first section 261 (refer to FIG. 12).

In the corresponding upstream region 900 of the region 61, the toner is not supplied to the specific regions 901 to 912, and the toner can be supplied to the regions other than the specific regions 901 to 912. Note that the toner is supplied to the corresponding downstream region 920 of the region 61.

Therefore, in the region 61, the toner is supplied to a comb-shaped region with continuous comb-like notches.

In this way, by setting a region where the toner adheres to avoid the grippers 45 of the transfer cylinder 26, the toner amount in the region 61 can be increased while preventing the toner from adhering to the grippers 45 of the transfer cylinder 26.

Further, widths DT of the specific regions 901 to 912 shown in FIG. 13 are dimensions of the specific regions 901 to 912 in the width direction B. The width DT is greater than the thickness t of the gripper 45 (refer to FIG. 4) (DT>t). A space is provided to prevent the toner from adhering to the grippers 45 even in a case where the intermediate transfer belt 21 is oblique.

Note that the widths DT of the specific regions 901 to 912 may be the same as the thickness t of the gripper 45 (refer to FIG. 4) (DT=t).

Here, in the example shown in FIG. 13, the broken lines 211 to 214 are not applied to the positions of the specific regions 901 to 912, but may be applied to the specific regions 901 to 912. That is, it does not mean that the broken lines 211 to 214 have to avoid the positions of the specific regions 901 to 912.

In addition, in FIG. 13, regions surrounded by the broken lines extending from the specific regions 901 to 912 in the right direction indicate regions held by the grippers 45 (refer to FIG. 12).

The specific regions 901 to 912 are examples of the region to which the developer is not supplied, and are examples of the region corresponding to the grip portion. Note that the specific regions 901 to 912 may be an example of the region corresponding to the grip portion, including the regions surrounded by the broken lines extending from the specific regions 901 to 912 in the right direction of FIG. 13.

### Meaning of Providing Corresponding Downstream Region 920 to Region 61

As described above, in the third exemplary embodiment, in the region 61 to which the toner is supplied, the toner is not supplied to the specific regions 901 to 912 in order to prevent the toner from adhering to the grippers 45. Therefore, for example, in the corresponding region 615 of the region 61, in the width direction B, the difference in the supplied toner amount is large between a portion where the specific region 912 is present and a portion where the specific region 912 is not present. Therefore, even in a case where the band is drawn in the corresponding region 615 on the basis of the average image density of the division region 521, the toner amount is small in the portion where the specific region 912 is present, and thus the blade 28 (refer to FIG. 1) may be unstable.

In a case where a modification example in which the corresponding downstream region 920 of the region 61 is omitted is adopted, a ratio of the supplied toner amount between the portion in which the specific region 912 is present and the portion in which the specific region 912 is not present is increased as compared with a case where the corresponding downstream region 920 is provided, and thus the instability of the blade 28 is promoted.

In addition, in the third exemplary embodiment, 12 regions of the specific regions 901 to 912 are provided for five regions of the corresponding regions 611 to 615, but the regions may be coped with by increasing the number of the intermediate regions. In such a correspondence, as the number of the intermediate regions is increased, the number of the division regions 521 to 525 is also increased. Therefore, a processing burden of the band drawing control (refer to FIG. 7) based on the average image density is increased.

Therefore, in the third exemplary embodiment, a configuration is adopted in which the region 61 is provided with not only the corresponding upstream region 900 including the specific regions 901 to 912 but also the corresponding downstream region 920. The corresponding downstream region 920 is an example of another region positioned to deviate in the one direction.

It should be noted that, in the third exemplary embodiment, as described in the second exemplary embodiment, by further including the region 63 provided over the entire area of the intermediate transfer belt 21 in the width direction B, the minimum value of the toner amount supplied to the margin region 53 in the width direction B is increased, and the stabilization of the blade 28 is achieved.

### Modification Example in Third Exemplary Embodiment

Here, in the third exemplary embodiment described above, by not supplying the toner to the specific regions 901 to 912 of the region 61, the adhesion of the toner to the grippers 45 is prevented. However, it is confirmed that, in a case of supplying the toner of only one color of YMCK, the adhesion of the toner to the grippers 45 is suppressed.

Therefore, a modification example may be adopted in which the toner of only one color of YMCK is supplied to the specific regions 901 to 912. In such a modification example, the toner amount on the intermediate transfer belt 21 in the width direction B is increased, and the stabilization of the blade 28 is achieved.

In the modification example, the developer supplied to the specific regions 901 to 912 as an example of the region corresponding to the grip portion is not a combination of the toners of two or more colors.

In such a modification example, in addition to a case where the toner of only one color of YMCK supplied to the specific regions 901 to 912 is the same color for all of the specific regions 901 to 912, a case where the toner of only one color of YMCK supplied to the specific regions 901 to 912 is not the same color for all of the specific regions 901 to 912 is considered. That is, the toner supplied to the specific regions 901 to 912 may be the toner of any one of YMCK, and the YMCK may be color-coded.

Note that, in a case where all the colors are the same, the control burden is reduced as compared with a case where the colors are not the same. On the other hand, in a case where the colors are not the same, the variation in the consumption amount of the toner of YMCK is suppressed as compared with a case where all the colors are the same.

An example of the description thereof will be described as an example in which Y is supplied to the specific regions 901, 905, and 909, M is supplied to the specific regions 902, 906, and 910, C is supplied to the specific regions 903, 907, and 911, and K is supplied to the specific regions 904, 908, and 912. That is, there is an example in which the color is changed in the specific region unit.

In addition, an example can also be considered in which the specific regions 901 to 912 are divided into, for example, four regions in the arrow direction A and the toner is supplied in the order of YMCK from the upstream side to the downstream side. That is, there is an example in which the color is changed in the arrow direction A.

### Supplementary Note

1

An image forming apparatus comprising:
an image holding body that holds an image developed with a developer on a surface in a state in which the image is arranged in one direction and that is movable in the one direction; and
a transfer member that transfers the image of the image holding body to a recording medium,
wherein, in a case where the surface of the image holding body is divided into a plurality of regions along a direction intersecting the one direction, for each of division regions that are the plurality of regions, a value derived based on information indicating an image density of the image on the surface is acquired, and
in a case where the derived value is less than a predetermined value, the developer is supplied to an intermediate region, which is a region between images transferred to the recording medium on the surface and is a region preceding a portion of the image in the corresponding division region.
   2

The image forming apparatus according to (((1))),
wherein the intermediate region includes a region to which the developer is not supplied.
   3

The image forming apparatus according to (((2))),
wherein a region where the developer is not held is a region corresponding to a grip portion that grips a part of the recording medium in a case where the transfer member includes the grip portion.
   4

The image forming apparatus according to (((3))),
wherein the region corresponding to the grip portion has a length in the intersecting direction greater than a dimension of the grip portion.
   5

The image forming apparatus according to (((3))) or (((4))),
wherein the region corresponding to the grip portion is a groove portion that accommodates the grip portion and does not include a portion in the one direction where the grip portion is not positioned.
   6

The image forming apparatus according to (((1))),
wherein in a case where the transfer member includes a grip portion that grips a part of the recording medium, the developer supplied to the region corresponding to the grip portion is not a combination of developers of two or more colors.
   7

The image forming apparatus according to (((6))),
wherein the developer supplied to the region corresponding to the grip portion is a plurality of color-coded developers of the image forming apparatus.
   8

The image forming apparatus according to (((6))),
wherein the developer supplied to the region corresponding to the grip portion is any one of a plurality of developers of the image forming apparatus.
   9

The image forming apparatus according to any one of (((3))) to (((8))),
wherein the intermediate region includes a region corresponding to the grip portion, and another region positioned to deviate from the region corresponding to the grip portion in the one direction.
   10

The image forming apparatus according to any one of (((1))) to (((9))),
wherein in a case where the developer is supplied to the intermediate region, the developer is supplied to a region over an entire area of the surface of the image holding body in a direction intersecting the one direction.
   11

The image forming apparatus according to (((10))),
wherein the region over the entire area is positioned on an upstream side of the intermediate region in the one direction.
   12

The image forming apparatus according to (((10))),
wherein a length of the intermediate region in the one direction is longer than the region over the entire area.
   13

The image forming apparatus according to any one of (((1))) to (((12))),
wherein the division region is set on the basis of a center position of the recording medium in a width dimension in the intersecting direction of the image holding body.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image holding body that holds an image developed with a developer on a surface in a state in which the image is arranged in one direction and that is movable in the one direction; and
a transfer member that transfers the image of the image holding body to a recording medium,
wherein, in a case where the surface of the image holding body is divided into a plurality of regions along a direction intersecting the one direction, for each of division regions that are the plurality of regions, a value derived based on information indicating an image density of the image on the surface is acquired, and
in a case where the derived value is less than a predetermined value, the developer is supplied to an intermediate region, which is a region between images transferred to the recording medium on the surface and is a region preceding a portion of the image in the corresponding division region.

2. The image forming apparatus according to claim 1,
wherein the intermediate region includes a region to which the developer is not supplied.

3. The image forming apparatus according to claim 2,
wherein a region where the developer is not held is a region corresponding to a grip portion that grips a part of the recording medium in a case where the transfer member includes the grip portion.

4. The image forming apparatus according to claim 3,
wherein the region corresponding to the grip portion has a length in the intersecting direction greater than a dimension of the grip portion.

5. The image forming apparatus according to claim 3,
wherein the region corresponding to the grip portion is a groove portion that accommodates the grip portion and does not include a portion in the one direction where the grip portion is not positioned.

6. The image forming apparatus according to claim 1,
wherein in a case where the transfer member includes a grip portion that grips a part of the recording medium, the developer supplied to the region corresponding to the grip portion is not a combination of developers of two or more colors.

7. The image forming apparatus according to claim 6,
wherein the developer supplied to the region corresponding to the grip portion is a plurality of color-coded developers of the image forming apparatus.

8. The image forming apparatus according to claim 6,
wherein the developer supplied to the region corresponding to the grip portion is any one of a plurality of developers of the image forming apparatus.

9. The image forming apparatus according to claim 3,
wherein the intermediate region includes a region corresponding to the grip portion, and another region positioned to deviate from the region corresponding to the grip portion in the one direction.

10. The image forming apparatus according to claim 6,
wherein the intermediate region includes a region corresponding to the grip portion, and another region positioned to deviate from the region corresponding to the grip portion in the one direction.

11. The image forming apparatus according to claim 1,
wherein in a case where the developer is supplied to the intermediate region, the developer is supplied to a region over an entire area of the surface of the image holding body in a direction intersecting the one direction.

12. The image forming apparatus according to claim 11,
wherein the region over the entire area is positioned on an upstream side of the intermediate region in the one direction.

13. The image forming apparatus according to claim 11,
wherein a length of the intermediate region in the one direction is longer than the region over the entire area.

14. The image forming apparatus according to claim 1,
wherein the division region is set on the basis of a center position of the recording medium in a width dimension in the intersecting direction of the image holding body.
